(19) United States
(12) Patent Application Publication
(10) Pub. No.: US 2021/0394338 A1
(43) Pub. Date: Dec. 23, 2021

(54) POLISHING APPARATUS AND PROGRAM

(71) Applicant: EBARA CORPORATION, Tokyo (JP)

(72) Inventors: Akira Nakamura, Tokyo (JP); Yuta Suzuki, Tokyo (JP); Shunsuke Sekiyama, Tokyo (JP)

(21) Appl. No.: 17/349,648

(22) Filed: Jun. 16, 2021

(30) Foreign Application Priority Data
Jun. 17, 2020 (JP) 2020-104283

(51) Int. Cl. B24B 51/00; B24B 37/013; B24B 49/14; B24B 49/16; G06K 9/62

(52) U.S. Cl. CPC B24B 51/00; B24B 37/013; G06N 20/00; B24B 49/16; G06K 9/6256; B24B 49/14

(57) ABSTRACT

A polishing apparatus comprises:
a generation unit configured to generate time-series data of a feature value up to a target time point by using data regarding a frictional force between a polishing member and a target substrate up to the target time point during polishing or a temperature measurement data of the polishing member or the target substrate; and
an prediction unit configured to input at least the time-series data of the feature value generated by the generation unit to a machine learning model trained with a training data set, and output an predicted value of a polishing amount or a residual film amount at the target time point during polishing of the target substrate.

### BACKGROUND

### Technical Field

The present technology relates to a polishing apparatus and a program.

### Related Art

A polishing apparatus for polishing a substrate (for example, a wafer) is known. For example, as disclosed in Japanese patent publication No. 2017-76779, there is known a technique for stopping polishing by detecting that a surface of underlayer is exposed and initial unevenness is flattened from a signal related to frictional force in polishing. This detection is also referred to as end point detection. For that detection, whether the signal waveform satisfies a predetermined condition is determined in real time, to determine the end point.

However, when the conventional end point detection method is used, there is a problem that the timings of the end point detection differ between substrates, so that the thicknesses (also referred to as residual film thicknesses) of the remaining films (also referred to as residual films) of the substrates are not constant.

In the conventional end point detection method, it is detected whether a simple numerical value (for example, inclination) characterizing a signal waveform related to a frictional force in polishing satisfies a predetermined condition, and predetermined additional polishing is performed after the detection. In actual polishing, for example, the polishing rates change due to the wear of a polishing pad, and the polishing profiles of the substrates are not always constant. In order to make the residual film thickness constant in accordance with the polishing situation (or state) that changes as described above, it has been necessary to establish a new end point detection method. In addition, in a case where the polishing amount or the residual film amount during polishing deviates from a predetermined condition, it is desirable that polishing can be performed so as to achieve a target polishing amount without increasing the polishing time, for example, by changing a polishing condition (for example, polishing pressure). In any case, even if the situation of polishing changes, it has been desired to estimate a parameter (for example, a polishing amount or a residual film amount, a polishing end point probability, and remaining polishing time or additional polishing time from the end point detection timing) at a target time point during polishing.

The present technology has been made in view of the above problems, and it is desirable to provide a polishing apparatus and a program capable of estimating a parameter at a target time point during polishing even when a polishing situation changes.

A polishing apparatus of one embodiment comprises: a generation unit configured to generate time-series data of a feature value up to a target time point by using data regarding a frictional force between a polishing member and a target substrate up to the target time point during polishing or a temperature measurement data of the polishing member or the target substrate; and an prediction unit configured to input at least the time-series data of the feature value generated by the generation unit to a machine learning model trained with a training data set including, as an input, time-series data of the feature value up to a specific time point during polishing of another substrate, and as an output, a polishing amount or a residual film amount at the specific time point, or time-series data of the polishing amount or the residual film amount up to the specific time point during polishing, the polishing amount or the residual film amount being predicted using at least a film thickness measured after polishing of the another substrate, and output an predicted value of a polishing amount or a residual film amount at the target time point during polishing of the target substrate.

A polishing apparatus of one embodiment, comprises: a generation unit configured to generate time-series data of a feature value up to a target time point by using data regarding a frictional force between a polishing member and a target substrate up to a target time point during polishing or a temperature measurement data of the polishing member or the target substrate; an prediction unit configured to input at least the time-series data of the feature value generated by the generation unit to a machine learning model trained with a training data set that includes, as an input, time-series data of the feature value up to a specific time point during polishing of another substrate and as an output, a polishing end point probability at the specific time point during polishing of the another substrate or time-series data of the polishing end point probability up to the specific time point, and output an predicted value of the polishing end point probability at the target time point of the target substrate; and a determination unit configured to determine whether or not a polishing end point has been reached by using the predicted value.

A polishing apparatus of one embodiment, comprises: a generation unit configured to generate time-series data of a feature value up to a target time point by using data regarding a frictional force between a polishing member and a target substrate up to the target time point during polishing or a temperature measurement data of the polishing member or the target substrate; and an prediction unit configured to input at least the time-series data of the feature value generated by the generation unit to a machine learning model trained with a training data set including, as an input, time-series data of the feature value up to a specific time point during polishing of another substrate, and as an output, a remaining polishing time at the specific time point or an additional polishing time from an end point detection timing, or time-series data of the a remaining polishing time up to the specific time point or the additional polishing time from the end point detection timing, the remaining polishing time or the additional polishing time being determined such that a remaining film thickness or a polishing amount of the another substrate becomes a target value, and output an predicted value of the remaining polishing time or the additional polishing time from an end point detection timing of the target substrate; and a determination unit that determines whether or not a polishing end point has been reached by using the predicted value.

A program of one embodiment for causing a computer to function as: a generation unit configured to generate time-series data of a feature value up to a target time point by using data regarding a frictional force between a polishing member and a target substrate up to the target time point during polishing or a temperature measurement data of the polishing member or the target substrate; and an prediction unit configured to input at least the time-series data of the feature value generated by the generation unit to a machine learning model trained with a training data set including, as an input, time-series data of the feature value up to a specific time point during polishing of another substrate, and as an output, a polishing amount or a residual film amount at the specific time point during polishing, or time-series data of the polishing amount or the residual film amount up to the specific time point, the polishing amount or the residual film amount being predicted by using at least a film thickness measured after polishing of the another substrate, and output an predicted value of the polishing amount or the residual film amount at the target time point during polishing of the target substrate.

A program of one embodiment for causing a computer to function as: a generation unit configured to generate time-series data of a feature value up to a target time point by using data regarding a frictional force between a polishing member and a target substrate up to the target time point during polishing or a temperature measurement data of the polishing member or the target substrate; and an prediction unit that inputs at least the time-series data of the feature value generated by the generation unit to a machine learning model trained with a training data set that includes, as an input, time-series data of the feature value up to a specific time point during polishing of another substrate, and as an output, a polishing end point probability at the specific time point or time-series data of the polishing end point probability up to the specific time point during polishing of the another substrate, and outputs an predicted value of the polishing end point probability at the target time point.

A program of one embodiment for causing a computer to function as: a generation unit configured to generate time-series data of a feature value up to a target time point by using data regarding a frictional force between a polishing member and a target substrate up to the target time point during polishing or a temperature measurement data of the polishing member or the target substrate; and an prediction unit configured to input at least time-series data of the feature value generated by the generation unit to a machine learning model trained with a training data set including, as an input, time-series data of the feature value up to a specific time point during polishing of another substrate, and as an output, a remaining polishing time at the specific time point or an additional polishing time from an end point detection timing or time-series data of the remaining polishing time up to the specific time point or the additional polishing time from the end point detection timing, the remaining polishing time or the additional polishing time being determined such that a remaining film thickness or a polishing amount of the another substrate becomes a target value, and output an estimation value of the additional polishing time from the remaining polishing time or the end point detection timing of the target substrate.

An information processing system of one embodiment comprises: a generation unit configured to generate time-series data of a feature value up to a target time point by using data regarding a frictional force between a polishing member and a target substrate up to the target time point during polishing or a temperature measurement data of the polishing member or the target substrate; and an prediction unit configured to input at least the time-series data of the feature value generated by the generation unit to a machine learning model trained with a training data set including, as an input, time-series data of the feature value up to a specific time point during polishing of another substrate, and as an output, a polishing amount or a residual film amount at the specific time point, or time-series data of the polishing amount or the residual film amount up to the specific time point during polishing, the polishing amount or the residual film amount being predicted using at least a film thickness measured after polishing of the another substrate, and output an predicted value of a polishing amount or a residual film amount at the target time point during polishing of the target substrate.

An information processing system of one embodiment comprises: a generation unit configured to generate time-series data of a feature value up to a target time point by using data regarding a frictional force between a polishing member and a target substrate up to a target time point during polishing or a temperature measurement data of the polishing member or the target substrate; an prediction unit configured to input at least the time-series data of the feature value generated by the generation unit to a machine learning model trained with a training data set that includes, as an input, time-series data of the feature value up to a specific time point during polishing of another substrate and as an output, a polishing end point probability at the specific time point during polishing of the another substrate or time-series data of the polishing end point probability up to the specific time point, and output an predicted value of the polishing end point probability at the target time point of the target substrate; and a determination unit configured to determine whether or not a polishing end point has been reached by using the predicted value.

An information processing system of one embodiment comprises: a generation unit configured to generate time-series data of a feature value up to a target time point by using data regarding a frictional force between a polishing member and a target substrate up to the target time point during polishing or a temperature measurement data of the polishing member or the target substrate; and an prediction unit configured to input at least the time-series data of the feature value generated by the generation unit to a machine learning model trained with a training data set including, as an input, time-series data of the feature value up to a specific time point during polishing of another substrate, and as an output, a remaining polishing time at the specific time point or an additional polishing time from an end point detection timing, or time-series data of the a remaining polishing time up to the specific time point or the additional polishing time from the end point detection timing, the remaining polishing time or the additional polishing time being determined such that a remaining film thickness or a polishing amount of the another substrate becomes a target value, and output an predicted value of the remaining polishing time or the additional polishing time from an end point detection timing of the target substrate; and a determination unit that determines whether or not a polishing end point has been reached by using the predicted value.

A substrate polishing method of one embodiment comprises: a generation step configured to generate time-series data of a feature value up to a target time point by using data regarding a frictional force between a polishing member and a target substrate up to the target time point during polishing or a temperature measurement data of the polishing member or the target substrate; and an estimation step configured to input at least the time-series data of the feature value generated by the generation step to a machine learning model trained with a training data set including, as an input, time-series data of the feature value up to a specific time point during polishing of another substrate, and as an output, a polishing amount or a residual film amount at the specific time point, or time-series data of the polishing amount or the residual film amount up to the specific time point during polishing, the polishing amount or the residual film amount being predicted using at least a film thickness measured after polishing of the another substrate, and output an predicted value of a polishing amount or a residual film amount at the target time point during polishing of the target substrate.

A substrate polishing method of one embodiment comprises: a generation step configured to generate time-series data of a feature value up to a target time point by using data regarding a frictional force between a polishing member and a target substrate up to a target time point during polishing or a temperature measurement data of the polishing member or the target substrate; an estimation step configured to input at least the time-series data of the feature value generated by the generation step to a machine learning model trained with a training data set that includes, as an input, time-series data of the feature value up to a specific time point during polishing of another substrate and as an output, a polishing end point probability at the specific time point during polishing of the another substrate or time-series data of the polishing end point probability up to the specific time point, and output an predicted value of the polishing end point probability at the target time point of the target substrate; and a determination step configured to determine whether or not a polishing end point has been reached by using the predicted value.

A substrate polishing method of one embodiment comprises: a generation step configured to generate time-series data of a feature value up to a target time point by using data regarding a frictional force between a polishing member and a target substrate up to the target time point during polishing or a temperature measurement data of the polishing member or the target substrate; and an estimation step configured to input at least the time-series data of the feature value generated by the generation step to a machine learning model trained with a training data set including, as an input, time-series data of the feature value up to a specific time point during polishing of another substrate, and as an output, a remaining polishing time at the specific time point or an additional polishing time from an end point detection timing, or time-series data of the a remaining polishing time up to the specific time point or the additional polishing time from the end point detection timing, the remaining polishing time or the additional polishing time being determined such that a remaining film thickness or a polishing amount of the another substrate becomes a target value, and output an predicted value of the remaining polishing time or the additional polishing time from an end point detection timing of the target substrate; and a determination step that determines whether or not a polishing end point has been reached by using the predicted value.

### BRIEF DESCRIPTION OF DRAWINGS

FIG. 1 is a schematic view illustrating an overall configuration of a polishing apparatus according to the first embodiment.

FIG. 2 is a schematic configuration diagram of the AI unit according to the first embodiment.

FIG. 3 is a diagram for describing a correspondence relationship between a polishing status of a wafer and a waveform of a table torque current.

FIG. 4 is a diagram for describing a difference between a detection point of conventional end point detection and an ideal detection point.

FIG. 5A is a schematic diagram illustrating an example of a training process and an prediction process according to the first embodiment.

FIG. 5B is an example of a graph illustrating a temporal change in the table torque current and a graph illustrating a temporal change in the polishing amount/residual film amount at that time.

FIG. 5C is a schematic diagram illustrating a first example of a learning method of the machine learning.

FIG. 5D is a schematic diagram illustrating a second example of the learning method of the machine learning.

FIG. 6 is a flowchart illustrating a first example of processing the AI unit during polishing of the wafer.

FIG. 7 is a flowchart illustrating a second example of processing the AI unit during polishing of the wafer.

FIG. 8 is a flowchart illustrating an example of processing of the AI unit during polishing of the wafer in the first modification of the first embodiment.

FIG. 9 is a flowchart illustrating an example of processing of the AI unit during polishing of the wafer in the second modification of the first embodiment.

FIG. 10 is a flowchart illustrating another example of processing the AI unit during polishing of the wafer in the second modification of the first embodiment.

FIG. 11 is a schematic view illustrating an overall configuration of a polishing system according to a second embodiment.

FIG. 12 is a schematic view illustrating an overall configuration of a polishing system according to a third embodiment.

### DETAILED DESCRIPTION

Hereinafter, a description will be given of each embodiment of the present invention with consultation of drawings. However, unnecessarily detailed description may be omitted. For example, a detailed description of a well-known matter and a repeated description of substantially the same configuration may be omitted. This is to avoid unnecessary redundancy of the following description and to facilitate understanding of those skilled in the art.

A polishing apparatus according to a first aspect of the present technology comprises: a generation unit configured to generate time-series data of a feature value up to a target time point by using data regarding a frictional force between a polishing member and a target substrate up to the target time point during polishing or a temperature measurement data of the polishing member or the target substrate; and an prediction unit configured to input at least the time-series data of the feature value generated by the generation unit to a machine learning model trained with a training data set including, as an input, time-series data of the feature value up to a specific time point during polishing of another substrate, and as an output, a polishing amount or a residual film amount at the specific time point, or time-series data of the polishing amount or the residual film amount up to the specific time point during polishing, the polishing amount or the residual film amount being predicted using at least a film thickness measured after polishing of the another substrate, and output an predicted value of a polishing amount or a residual film amount at the target time point during polishing of the target substrate.

With this configuration, a relationship between a feature value related to a change in a frictional force or temperature when polishing is performed and a polishing amount or a residual film amount as a result of polishing is trained, and the polishing amount or the residual film amount during polishing of a new substrate is predicted using the trained machine learning model. By the learning of the machine learning model, the trained machine learning model can estimate a polishing amount or a residual film amount in consideration of the influence of the consumable member such as the polishing pad and the non-uniformity of polishing. Therefore, it is possible to estimate the polishing amount or the residual film amount during polishing of a new substrate in consideration of the influence of the consumable member such as the polishing pad and the non-uniformity of polishing. By using the predicted value for detecting the polishing end point of the target substrate, it is possible to realize end point detection capable of suppressing the difference in residual film thickness between the substrates even if the polishing situation changes.

A polishing apparatus according to a second aspect of the present technology, in the polishing apparatus according to the first aspect, further comprises: a determination unit configured to determine whether or not an polishing end point has been reached by using the predicted value; and a control unit configured to control the polishing apparatus so as to stop polishing in a case where the determination unit determines that the polishing end point has been reached.

According to this configuration, since it is possible to control the polishing apparatus so as to stop polishing by using the polishing amount or the residual film amount during polishing predicted in consideration of the influence of consumable members such as polishing pads and non-uniformity of substrates, the difference between the substrates in the polishing amount or the residual film amount at the end of polishing can be reduced.

A polishing apparatus according to a third aspect of the present technology, in the polishing apparatus according to the first or second aspect, wherein the input of the machine learning model further includes a polishing recipe, a use time of one consumable member, the number of substrates treated with the consumable member, and/or an initial film thickness.

According to this configuration, it is possible to estimate the polishing amount or the residual film amount according to the polishing condition and the state of the consumable members, so that the estimation accuracy can be improved.

A polishing apparatus according to a forth aspect of the present technology, in the polishing apparatus according to any one of the first to third aspect, wherein the polishing amount or the residual film amount at each time point in the training data set is calculated using a first polishing rate until an interface between a polishing target layer and a lower layer is exposed and a second polishing rate after the interface is exposed.

A polishing apparatus according to a fifth aspect of the present technology comprises: a generation unit configured to generate time-series data of a feature value up to a target time point by using data regarding a frictional force between a polishing member and a target substrate up to a target time point during polishing or a temperature measurement data of the polishing member or the target substrate; an prediction unit configured to input at least the time-series data of the feature value generated by the generation unit to a machine learning model trained with a training data set that includes, as an input, time-series data of the feature value up to a specific time point during polishing of another substrate and as an output, a polishing end point probability at the specific time point during polishing of the another substrate or time-series data of the polishing end point probability up to the specific time point, and output an predicted value of the polishing end point probability at the target time point of the target substrate; and a determination unit configured to determine whether or not a polishing end point has been reached by using the predicted value.

According to this configuration, the relationship between the feature value related to a change in a frictional force or temperature when polishing is performed and the polishing end point probability at each time point during polishing is trained, and a polishing end point probability at each time point during polishing of a new substrate is predicted using the trained machine learning model. By the learning of the machine learning model, the trained machine learning model can estimate a polishing end point probability at each time point during polishing in consideration of the influence of the consumable member such as the polishing pad and the non-uniformity of polishing, and thus, it is possible to estimate the polishing end point probability at each time point during polishing of a new substrate in consideration of the influence of the consumable member such as the polishing pad and the non-uniformity of polishing. By using the predicted value for detecting the polishing end point of the target substrate, it is possible to realize end point detection capable of suppressing the difference in residual film thickness between the substrates even if the polishing situation changes.

A polishing apparatus according to a sixth aspect of the present technology, in the polishing apparatus according to the fifth aspect, comprises: a control unit configured to control the polishing apparatus so as to stop polishing in a case where the determination unit determines that the polishing end point has been reached.

According to this configuration, since the influence of the consumable members such as a polishing pad and non-uniformity of substrates can be taken into consideration, a deviation range of the polishing amount or the residual film amount at the end of polishing can be reduced.

A polishing apparatus according to a seventh aspect of the present technology comprises: a generation unit configured to generate time-series data of a feature value up to a target time point by using data regarding a frictional force between a polishing member and a target substrate up to the target time point during polishing or a temperature measurement data of the polishing member or the target substrate; and an prediction unit configured to input at least the time-series data of the feature value generated by the generation unit to a machine learning model trained with a training data set including, as an input, time-series data of the feature value up to a specific time point during polishing of another substrate, and as an output, a remaining polishing time at the specific time point or an additional polishing time from an end point detection timing, or time-series data of the a remaining polishing time up to the specific time point or the additional polishing time from the end point detection timing, the remaining polishing time or the additional polishing time being determined such that a remaining film thickness or a polishing amount of the another substrate becomes a target value, and output an predicted value of the remaining polishing time or the additional polishing time from an end point detection timing of the target substrate; and a determination unit that determines whether or not a polishing end point has been reached by using the predicted value.

According to this configuration, the relationship between the feature value related to a change in the frictional force or temperature at the time of polishing and the remaining polishing time or the additional polishing time from the end point detection timing is trained, and a remaining polishing time or additional polishing time from the end point detection timing during polishing of a new substrate is predicted using the trained machine learning model. By the learning of the machine learning model, the trained machine learning model can estimate the remaining polishing time or the additional polishing time from the end point detection timing in consideration of the influence of the consumable member such as the polishing pad and the non-uniformity of polishing. Therefore, the remaining polishing time or the additional polishing time from the end point detection timing during the polishing of the new substrate can be predicted in consideration of the influence of the consumable member such as the polishing pad and the non-uniformity of polishing. By using the predicted value for detecting the polishing end point of the target substrate, it is possible to realize end point detection capable of suppressing the difference in residual film thickness between the substrates even if the polishing situation changes.

A polishing apparatus according to an eighth aspect of the present technology, in the polishing apparatus according to the seventh aspect, further comprises: a control unit configured to control the polishing apparatus so as to stop polishing by using the predicted value of the remaining polishing time or the additional polishing time from the end point detection timing.

According to this configuration, since the influence of the consumable members such as a polishing pad and non-uniformity of substrates can be taken into consideration, a deviation range of the polishing amount or the residual film amount at the end of polishing can be reduced.

A program, according to a ninth aspect of the present technology, for causing a computer to function as: a generation unit configured to generate time-series data of a feature value up to a target time point by using data regarding a frictional force between a polishing member and a target substrate up to the target time point during polishing or a temperature measurement data of the polishing member or the target substrate; and an prediction unit configured to input at least the time-series data of the feature value generated by the generation unit to a machine learning model trained with a training data set including, as an input, time-series data of the feature value up to a specific time point during polishing of another substrate, and as an output, a remaining polishing time at the specific time point or an additional polishing time from an end point detection timing, or time-series data of the a remaining polishing time up to the specific time point or the additional polishing time from the end point detection timing, the remaining polishing time or the additional polishing time being determined such that a remaining film thickness or a polishing amount of the another substrate becomes a target value, and output an predicted value of the remaining polishing time or the additional polishing time from an end point detection timing of the target substrate; and a determination unit that determines whether or not a polishing end point has been reached by using the predicted value.

A program, according to a tenth aspect of the present technology, for causing a computer to function as: a generation unit configured to generate time-series data of a feature value up to a target time point by using data regarding a frictional force between a polishing member and a target substrate up to the target time point during polishing or a temperature measurement data of the polishing member or the target substrate; and an prediction unit that inputs at least the time-series data of the feature value generated by the generation unit to a machine learning model trained with a training data set that includes, as an input, time-series data of the feature value up to a specific time point during polishing of another substrate, and as an output, a polishing end point probability at the specific time point or time-series data of the polishing end point probability up to the specific time point during polishing of the another substrate, and outputs an predicted value of the polishing end point probability at the target time point.

A program, according to an eleventh aspect of the present technology, for causing a computer to function as: a generation unit configured to generate time-series data of a feature value up to a target time point by using data regarding a frictional force between a polishing member and a target substrate up to the target time point during polishing or a temperature measurement data of the polishing member or the target substrate; and an prediction unit configured to input at least time-series data of the feature value generated by the generation unit to a machine learning model trained with a training data set including, as an input, time-series data of the feature value up to a specific time point during polishing of another substrate, and as an output, a remaining polishing time at the specific time point or an additional polishing time from an end point detection timing or time-series data of the remaining polishing time up to the specific time point or the additional polishing time from the end point detection timing, the remaining polishing time or the additional polishing time being determined such that a remaining film thickness or a polishing amount of the another substrate becomes a target value, and output an estimation value of the additional polishing time from the remaining polishing time or the end point detection timing of the target substrate.

An information processing system according to a twelfth aspect of the present technology comprises: a generation unit configured to generate time-series data of a feature value up to a target time point by using data regarding a frictional force between a polishing member and a target substrate up to the target time point during polishing or a temperature measurement data of the polishing member or the target substrate; and an prediction unit configured to input at least the time-series data of the feature value generated by the generation unit to a machine learning model trained with a training data set including, as an input, time-series data of the feature value up to a specific time point during polishing of another substrate, and as an output, a polishing amount or a residual film amount at the specific time point, or time-series data of the polishing amount or the residual film amount up to the specific time point during polishing, the polishing amount or the residual film amount being predicted using at least a film thickness measured after polishing of the another substrate, and output an predicted value of a polishing amount or a residual film amount at the target time point during polishing of the target substrate.

An information processing system according to a thirteenth aspect of the present technology comprises: a generation unit configured to generate time-series data of a feature value up to a target time point by using data regarding a frictional force between a polishing member and a target substrate up to a target time point during polishing or a temperature measurement data of the polishing member or the target substrate; an prediction unit configured to input at least the time-series data of the feature value generated by the generation unit to a machine learning model trained with a training data set that includes, as an input, time-series data of the feature value up to a specific time point during polishing of another substrate and as an output, a polishing end point probability at the specific time point during polishing of the another substrate or time-series data of the polishing end point probability up to the specific time point, and output an predicted value of the polishing end point probability at the target time point of the target substrate; and a determination unit configured to determine whether or not a polishing end point has been reached by using the predicted value.

An information processing system according to a fourteenth aspect of the present technology comprises: a generation unit configured to generate time-series data of a feature value up to a target time point by using data regarding a frictional force between a polishing member and a target substrate up to the target time point during polishing or a temperature measurement data of the polishing member or the target substrate; and an prediction unit configured to input at least the time-series data of the feature value generated by the generation unit to a machine learning model trained with a training data set including, as an input, time-series data of the feature value up to a specific time point during polishing of another substrate, and as an output, a remaining polishing time at the specific time point or an additional polishing time from an end point detection timing, or time-series data of the a remaining polishing time up to the specific time point or the additional polishing time from the end point detection timing, the remaining polishing time or the additional polishing time being determined such that a remaining film thickness or a polishing amount of the another substrate becomes a target value, and output an predicted value of the remaining polishing time or the additional polishing time from an end point detection timing of the target substrate; and a determination unit that determines whether or not a polishing end point has been reached by using the predicted value.

A substrate polishing method according to a fifteenth aspect of the present technology comprises: a generation step configured to generate time-series data of a feature value up to a target time point by using data regarding a frictional force between a polishing member and a target substrate up to the target time point during polishing or a temperature measurement data of the polishing member or the target substrate; and an estimation step configured to input at least the time-series data of the feature value generated by the generation step to a machine learning model trained with a training data set including, as an input, time-series data of the feature value up to a specific time point during polishing of another substrate, and as an output, a polishing amount or a residual film amount at the specific time point, or time-series data of the polishing amount or the residual film amount up to the specific time point during polishing, the polishing amount or the residual film amount being predicted using at least a film thickness measured after polishing of the another substrate, and output an predicted value of a polishing amount or a residual film amount at the target time point during polishing of the target substrate.

A substrate polishing method according to a sixteenth aspect of the present technology comprises: a generation step configured to generate time-series data of a feature value up to a target time point by using data regarding a frictional force between a polishing member and a target substrate up to a target time point during polishing or a temperature measurement data of the polishing member or the target substrate; an estimation step configured to input at least the time-series data of the feature value generated by the generation step to a machine learning model trained with a training data set that includes, as an input, time-series data of the feature value up to a specific time point during polishing of another substrate and as an output, a polishing end point probability at the specific time point during polishing of the another substrate or time-series data of the polishing end point probability up to the specific time point, and output an predicted value of the polishing end point probability at the target time point of the target substrate; and a determination step configured to determine whether or not a polishing end point has been reached by using the predicted value.

A substrate polishing method according to a seventeenth aspect of the present technology comprises: a generation step configured to generate time-series data of a feature value up to a target time point by using data regarding a frictional force between a polishing member and a target substrate up to the target time point during polishing or a temperature measurement data of the polishing member or the target substrate; and an estimation step configured to input at least the time-series data of the feature value generated by the generation step to a machine learning model trained with a training data set including, as an input, time-series data of the feature value up to a specific time point during polishing of another substrate, and as an output, a remaining polishing time at the specific time point or an additional polishing time from an end point detection timing, or time-series data of the a remaining polishing time up to the specific time point or the additional polishing time from the end point detection timing, the remaining polishing time or the additional polishing time being determined such that a remaining film thickness or a polishing amount of the another substrate becomes a target value, and output an predicted value of the remaining polishing time or the additional polishing time from an end point detection timing of the target substrate; and a determination step that determines whether or not a polishing end point has been reached by using the predicted value.

According to one aspect of the present technology, a relationship between a feature value related to a change in a frictional force or temperature when polishing is performed and a polishing amount or a residual film amount as a result of polishing is trained, and the polishing amount or the residual film amount during polishing of a new substrate is predicted using the trained machine learning model. By the learning of the machine learning model, the trained machine learning model can estimate a polishing amount or a residual film amount in consideration of the influence of the consumable member such as the polishing pad and the non-uniformity of polishing. Therefore, it is possible to estimate the polishing amount or the residual film amount during polishing of a new substrate in consideration of the influence of the consumable member such as the polishing pad and the non-uniformity of polishing.

According to one aspect of the present technology, the relationship between the feature value related to a change in a frictional force or temperature when polishing is performed and the polishing end point probability at each time point during polishing is trained, and a polishing end point probability at each time point during polishing of a new substrate is predicted using the trained machine learning model. By the learning of the machine learning model, the trained machine learning model can estimate a polishing end point probability at each time point during polishing in consideration of the influence of the consumable member such as the polishing pad and the non-uniformity of polishing, and thus, it is possible to estimate the polishing end point probability at each time point during polishing of a new substrate in consideration of the influence of the consumable member such as the polishing pad and the non-uniformity of polishing.

According to one aspect of the present technology, the relationship between the feature value related to a change in the frictional force or temperature at the time of polishing and the remaining polishing time or the additional polishing time from the end point detection timing is trained, and a remaining polishing time or additional polishing time from the end point detection timing during polishing of a new substrate is predicted using the trained machine learning model. By the learning of the machine learning model, the trained machine learning model can estimate the remaining polishing time or the additional polishing time from the end point detection timing in consideration of the influence of the consumable member such as the polishing pad and the non-uniformity of polishing. Therefore, the remaining polishing time or the additional polishing time from the end point detection timing during the polishing of the new substrate can be predicted in consideration of the influence of the consumable member such as the polishing pad and the non-uniformity of polishing.

The inventors of the present application have found that there is a correlation between a feature value related to a change in a frictional force or temperature when polishing is performed and a polishing amount or a residual film amount as a result of polishing. In addition, the inventors of the present application have found that there is a correlation between the feature value related to the change in the frictional force or temperature when polishing is performed and a polishing end point probability at each time point during polishing. Further, the inventors of the present application have found that there is a correlation between the feature value related to the change in the frictional force or temperature when polishing is performed and the remaining polishing time or the additional polishing time from the end point detection timing. Therefore, in each embodiment, a machine learning model (for example, a recurrent neural network or a long short-term memory (LSTM)) is used to learn one of the relationships described above. In each embodiment, a wafer will be described as an example of the substrate.

### First Embodiment

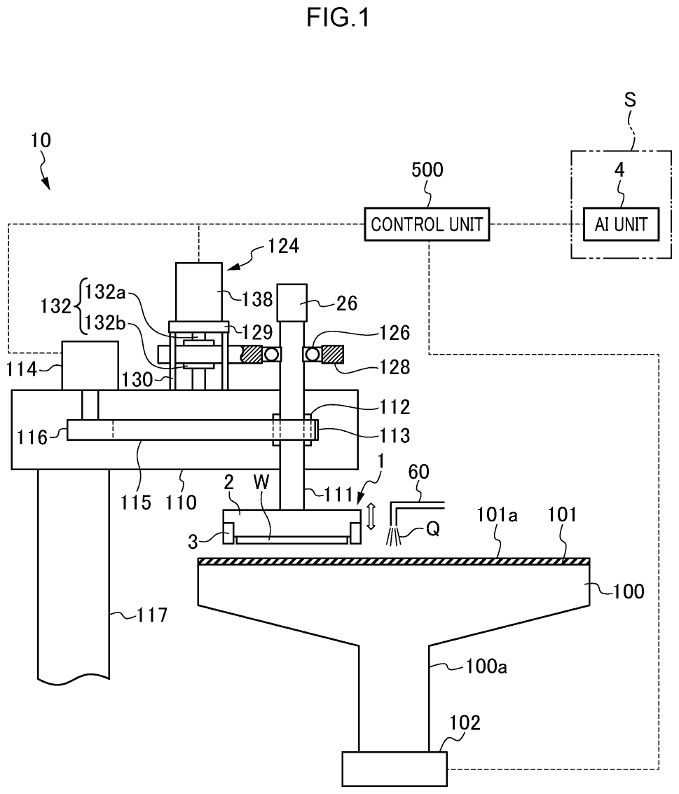

First, a first embodiment will be described. FIG. 1 is a schematic view illustrating an overall configuration of a polishing apparatus according to the first embodiment. As illustrated in FIG. 1, a polishing apparatus 10 has an information processing system S, and the information processing system S has an AI unit 4. Note that the information processing system S may further has a control unit 500.

The polishing apparatus 10 includes a polishing table 100 and a polishing head 1 as a substrate holding apparatus that holds a substrate (here, a wafer) to be polished and presses the substrate against a polishing surface on the polishing table 100. The polishing head 1 is also referred to as a top ring. The polishing table 100 is connected to a table rotating motor 102 via a table shaft 100a, that is disposed therebelow. The polishing table 100 rotates around the table shaft 100a as the table rotating motor 102 rotates. A polishing pad 101 as a polishing member is attached to the upper surface of the polishing table 100. The surface of the polishing pad 101 constitutes a polishing surface 101a for polishing a semiconductor wafer W. As described above, the polishing apparatus 10 includes the polishing table 100 provided with a polishing member (here, the polishing pad 101 as an example) and configured to be rotatable, and the polishing head 1 that is configured to face the polishing table 100 and be rotatable and to which a substrate (here, the wafer) can be attached on a surface facing the polishing table 100.

A polishing liquid supply nozzle 60 is installed above the polishing table 100. A polishing liquid (polishing slurry) Q is supplied from the polishing liquid supply nozzle 60 onto the polishing pad 101 on the polishing table 100.

The polishing head 1 basically includes a top ring main body 2 that presses the semiconductor wafer W against the polishing surface 101a, and a retainer ring 3 as a retainer member that holds an outer peripheral edge of the semiconductor wafer W and prevents the semiconductor wafer W from jumping out of the polishing head 1. The polishing head 1 is connected to a top ring shaft 111. The top ring shaft 111 is moved up and down with respect to a top ring head 110 by a vertical movement mechanism 124. Positioning of the polishing head 1 in a vertical direction is performed by a vertical movement of the entire polishing head 1 with respect to the top ring head 110 by moving the top ring shaft 111 up and down. A rotary joint 26 is attached to an upper end of the top ring shaft 111.

The vertical movement mechanism 124 that vertically moves the top ring shaft 111 and the polishing head 1 includes a bridge 128 that rotatably supports the top ring shaft 111 via a bearing 126, a ball screw 132 attached to the bridge 128, a support base 129 supported by a support column 130, and a servomotor 138 provided on the support base 129. The support base 129 that supports the servomotor 138 is fixed to the top ring head 110 via the support column 130.

The ball screw 132 includes a screw shaft 132a connected to the servomotor 138 and a nut 132b to which the screw shaft 132a is screwed. When the servomotor 138 is driven, the bridge 128 moves up and down via the ball screw 132, whereby the top ring shaft 111 and the polishing head 1 moving up and down integrally with the bridge 128 that moves up and down.

In addition, as illustrated in FIG. 1, by rotationally driving a top ring rotating motor 114, a rotary cylinder 112 and the top ring shaft 111 are integrally rotated via a timing pulley 116, a timing belt 115, and a timing pulley 113, and the polishing head 1 is rotated.

The top ring head 110 is supported by a top ring head shaft 117 rotatably supported by a frame (not illustrated). The polishing apparatus 10 is connected to each device in the apparatus including the top ring rotating motor 114, the servomotor 138, and the table rotating motor 102 via a control line, and includes a control unit 500 that controls each device. The control unit 500 controls the polishing apparatus so as to polish the substrate by pressing the substrate against the polishing member (here, the polishing pad 101) while rotating the polishing head 1 to which the substrate is attached and the polishing table 100.

Although there are table rotation, head rotation, and rotation of a motor (not illustrated) for rocking the top ring head 110, and these are to be used as the basis of features to be input to a machine learning model to be described later, one or more sensor detected values (for example, motor current value) or a calculated value of torque calculated from the sensor detected value may be used.

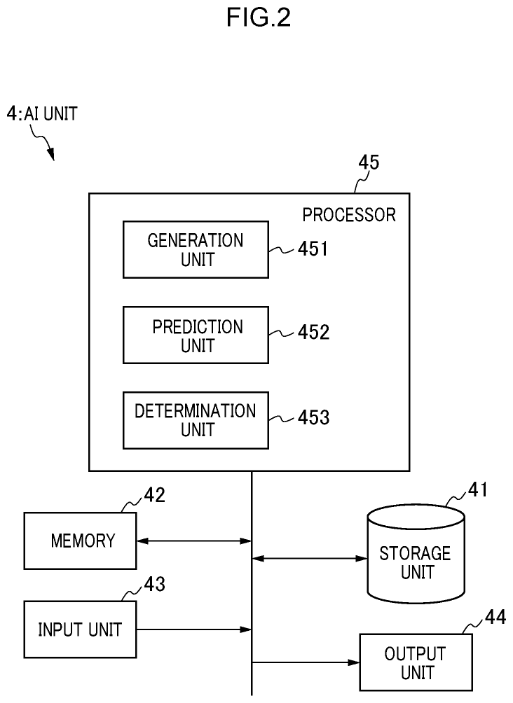

The polishing apparatus 10 includes the AI unit 4 connected to the control unit 500 via wiring. FIG. 2 is a schematic configuration diagram of the AI unit according to the first embodiment. As illustrated in FIG. 2, the AI unit 4 is, for example, a computer, and includes a storage unit 41, a memory 42, an input unit 43, an output unit 44, and a processor 45.

The storage unit 41 stores a machine learning model trained with a training data set that includes, as an input, a feature value based on data regarding a frictional force at each time point during polishing or a feature value based on temperature measurement data, and as an output, a polishing amount or a residual film amount at each time point during polishing predicted by using at least a film thickness measured after polishing. The storage unit 41 also stores a program to be read and executed by the processor 45. The storage unit 41 may be a storage such as a hard disk or a DVD, an external storage medium such as an SD card or a flash memory, an online storage, or a storage device.

Here, the data regarding the frictional force at each time point during polishing is, for example, a current value (hereinafter, also referred to as table torque current) for torque calculation of the table rotating motor 102 during polishing. Here, the data regarding the frictional force at each time point during polishing may be a calculated value of torque converted from the current value of the motor. Note that the data regarding the frictional force at each time point during polishing may be a drive current value of the top ring rotating motor 114 that rotates the polishing head 1, or may be a drive current value of a motor (not illustrated) that rotates the top ring head 110 (thus, the top ring head shaft 117).

In addition, the polishing apparatus 10 may include a load cell that measures a frictional force between the polishing member and the substrate, and in this case, the data regarding the frictional force at each time point during polishing may be a signal value of the load cell. The polishing apparatus 10 may include a strain sensor that measures the strain of the substrate. In this case, the data regarding the frictional force at each time point during polishing may be a signal value of the strain sensor.

The memory 42 is a medium that temporarily stores information.

The input unit 43 receives information from the control unit 500 and outputs the information to the processor 45.

The output unit 44 receives information from the processor 45 and outputs the information to the control unit 500.

The processor 45 functions as a generation unit 451, an prediction unit 452, and a determination unit 453 by reading a program from the storage unit 41 to execute the program.

For example, the generation unit 451 generates a feature value using the data regarding the frictional force between the polishing member and a target substrate at a target time point during polishing. Here, “during polishing” means, for example, during polishing of a substrate by pressing the substrate against a polishing member while rotating the polishing head 1 to which the substrate is attached and the polishing table 100. Details of this process will be described later.

The prediction unit 452 inputs at least the feature value generated by the generation unit 451 to the trained machine learning model, and outputs an predicted value of the polishing amount or the residual film amount at the target time point during polishing of the target substrate. Details of this process will be described later. The determination unit 453 uses the predicted value to determine whether or not the polishing end point has been reached.

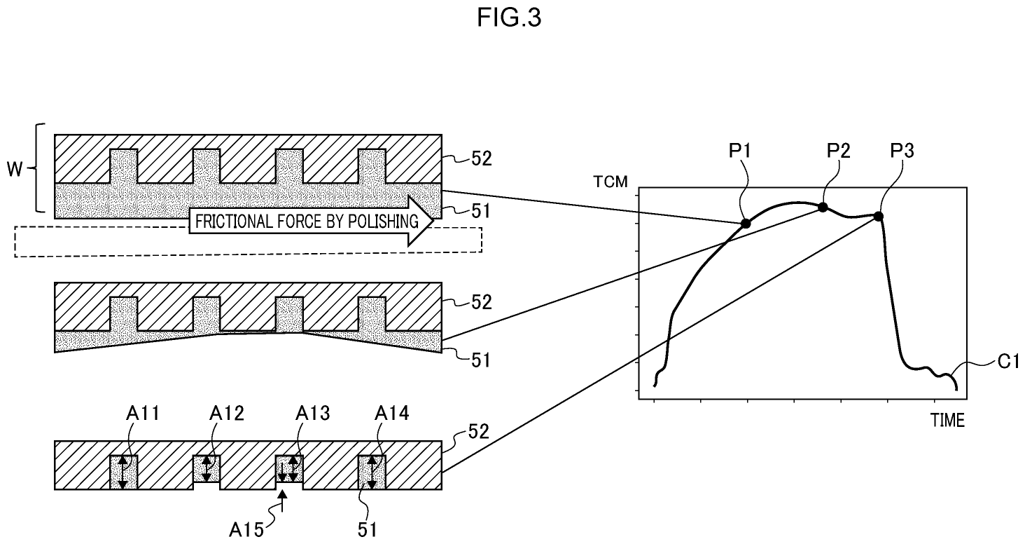

FIG. 3 is a diagram for describing a correspondence relationship between a polishing status of a wafer and a waveform of a table torque current. The vertical axis of the graph illustrated in FIG. 3 is the torque current value of the table rotating motor 102 during polishing, the horizontal axis is time, and a waveform C1 indicating the time change of the table torque current is illustrated. Since the frictional force with the polishing pad 101 changes depending on the exposed film type ratio, the value of the table torque current also changes accordingly.

As illustrated in FIG. 3, the wafer W has a polishing target layer 51 attached so as to face the polishing pad 101, and a lower layer 52 provided on the polishing target layer 51. The polishing target layer 51 is reduced by the force of friction due to polishing. At a point P1 on the waveform C1, the polishing target layer 51 is not reduced much, and at a point P2 on the waveform C1 at which time has further elapsed, the lower layer 52 is partially exposed. At a point P3 on the waveform C1 after a further lapse of time, the lower layer 52 is exposed over the entire surface. When the lower layer 52 is exposed over the entire surface, the table rotating motor 102 is stopped, and the polishing is stopped.

As the lengths of arrows A12 and A13 are shorter than the lengths of arrows A11 and A14 in FIG. 3, excessive polishing is performed by the amount of an arrow A15.

The inventor of the present application has found that there is a correlation between the data on the frictional force between the polishing member and the substrate (for example, the signal of the table torque current) and the residual film thickness or the polishing amount, since the polishing rate varies depending on the polishing position due to wear of the polishing pad or the like and the timing at which the lower layer film is exposed varies in the wafer plane due to uneven polishing of the film or the like. Here, the residual film thickness is a remaining thickness of the polishing target layer 51, that is, a thickness from the bottom in the recess to the lower surface of the polishing target layer 51, and is, for example, a thickness (for example, the lengths of arrows A11, A12, A13, A14) of the film remaining in the recess in a case of interface protrusion as indicated by the point P3 in FIG. 3. The residual film thickness may be a residual film thickness at a certain determined position, or may be an average value of residual film thicknesses measured at a plurality of positions. The polishing amount is, for example, a thickness of the polishing target layer 51 reduced by polishing. The polishing amount may be a polishing amount at a predetermined position or an average value of polishing amounts measured at a plurality of positions.

Therefore, in the present embodiment, a machine learning model is caused to learn with a training data set in which data regarding the frictional force between the polishing member and the substrate when a substrate having a certain initial film thickness is polished to a certain residual film thickness is used as an input, and the residual film thickness or the polishing amount at that time point is used as an output, and the trained machine learning model is caused to read data regarding a frictional force between a polishing member and a substrate to be newly targeted, so that an predicted value of the residual film thickness or the polishing amount is output, and the polishing is stopped at the timing when the residual film thickness or the polishing amount becomes a target value.

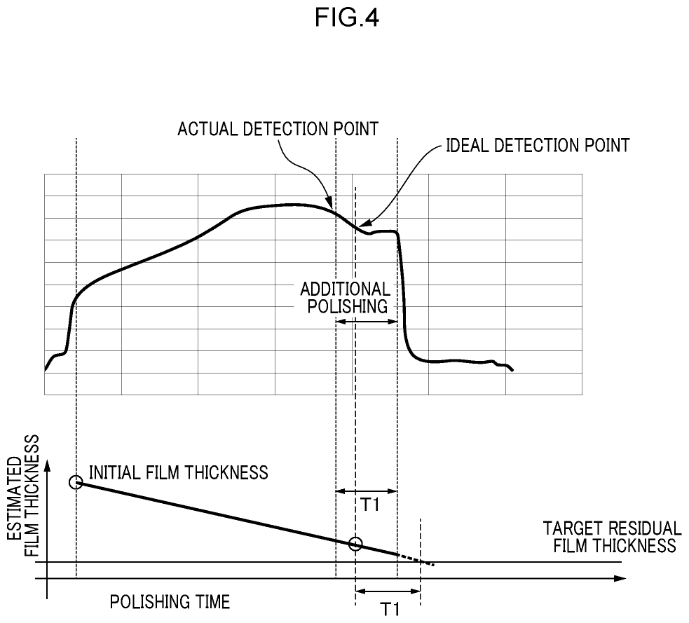

FIG. 4 is a diagram for describing a difference between a detection point of conventional end point detection and an ideal detection point. As illustrated in FIG. 4, since the detection point (actual detection point) of the conventional end point detection is earlier than the ideal detection point, there has been a problem that the film thickness cannot be reduced until reaching the target residual film thickness even when additional polishing (also referred to as overpolishing) is performed for a predetermined period T1 thereafter. On the other hand, when the detection point of the end point detection coincides with the ideal detection point, the film can be reduced until the film thickness reaches the target residual film thickness in a case of further polishing for the subsequent predetermined period T1, and thus it is desirable to detect the end point at the ideal detection point.

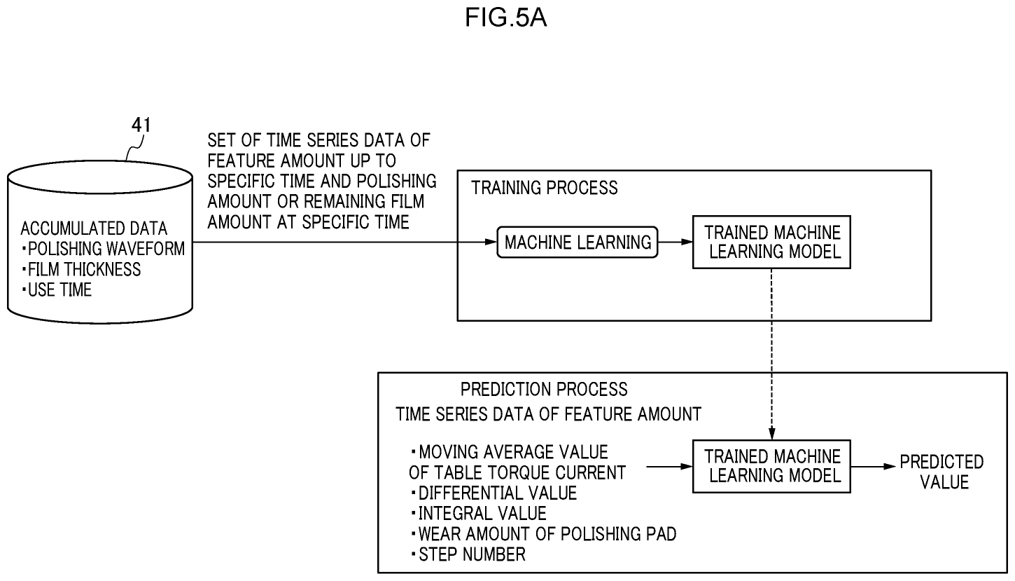

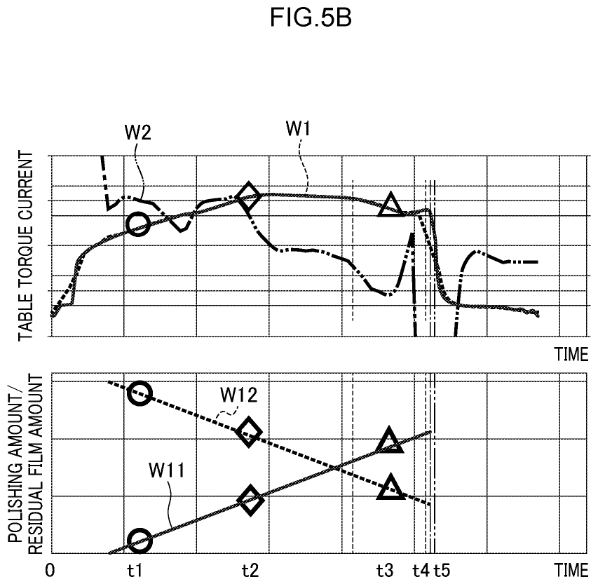

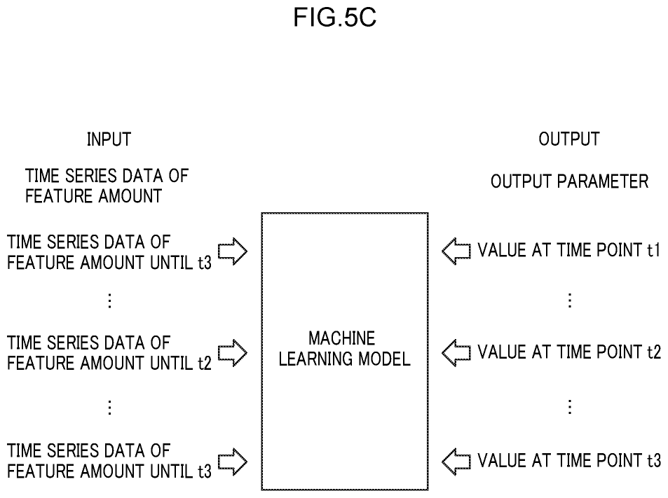

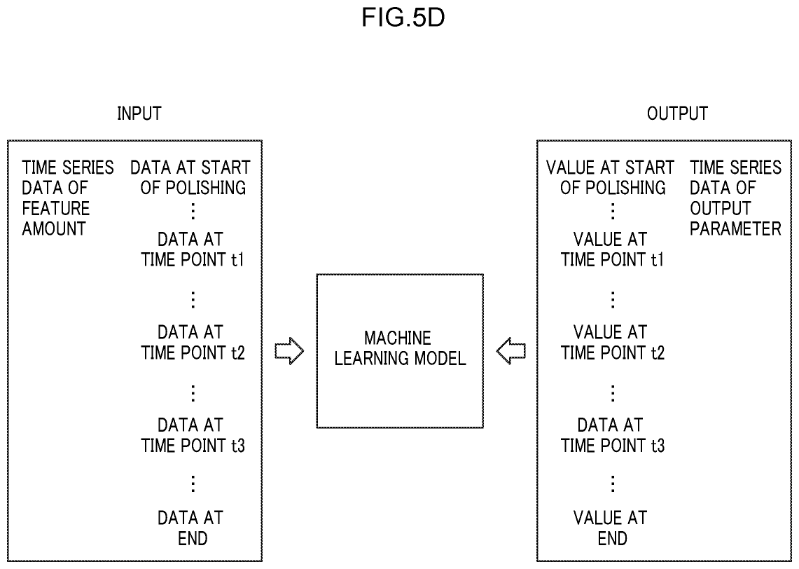

FIG. 5A is a schematic diagram illustrating an example of a training process and an prediction process according to the first embodiment. As illustrated in FIG. 5A, the storage unit 41 stores, as accumulated data, data regarding waveforms of various signals during polishing (also referred to as polishing waveforms), film thicknesses after polishing, use time of the consumable members (for example, polishing pads), and the like. However, the use time of the consumable members may not be necessary. A polishing state may change depending on the use time of a polishing pad. In the training process, learning data using a polishing pad in various states from immediately after the start of using the polishing pad to a stage where the wear has progressed is collectively trained with the machine learning model without setting the use time of the polishing pad as a parameter, and in a case where the residual film thickness or the polishing amount can be appropriately predicted, it is not necessary to include the use time of the polishing pad in the accumulated data. However, the residual film thickness or the polishing amount may be predicted according to the use time of the polishing pad at the time of polishing the target substrate by putting the use time of the polishing pad in the accumulated data.

In the training process, the feature value based on the data (for example, table torque current) regarding a frictional force between the polishing member and the substrate at each time point during polishing is extracted with reference to the storage unit 41. In addition, with reference to the storage unit 41, the polishing amount or the residual film amount at each time point during polishing predicted using at least the film thickness measured after polishing is extracted.

Machine learning is performed using the training data set that includes, as an input, a feature value based on the data regarding the frictional force between the polishing member and the substrate at each time point during polishing, and as an output, a polishing amount or a residual film amount at each time point during polishing predicted using at least the film thickness measured after polishing. As a result, the trained machine learning model is stored in the storage unit 41. In addition to the feature value based on the data regarding the frictional force between the polishing member and the substrate at each time point during polishing, as the input in the training data set, a polishing recipe, a use time of one consumable member, the number of substrates processed with a same consumable member, and/or the initial film thickness may be added as described later.

Here, the polishing amount or the residual film amount at each time point in the training data set is obtained by calculating the polishing amount or the residual film amount (residual film thickness) at each time point on the basis of the measurement result of the initial film thickness and the film thickness after polishing, assuming that the polishing rate during polishing is constant. Alternatively, a change in the polishing rate during polishing may be obtained by an experiment to calculate the polishing amount or the residual film amount at each time point. Note that a first polishing rate until an interface between the polishing target layer and the lower layer is exposed and a second polishing rate after the interface is exposed may be calculated separately.

FIG. 5B is an example of a graph illustrating a temporal change in the table torque current and a graph illustrating a temporal change in the polishing amount/residual film amount at that time. As illustrated in FIG. 5B, a curve W1 indicates a temporal change in a moving average of the table torque current, and a curve W2 indicates a temporal change in a differential value of the table torque current. t4 is a polishing end time, and t5 is an ideal polishing end time. A curve W11 indicates a temporal change in the polishing amount, and a curve W12 indicates a residual film amount.

FIG. 5C is a schematic diagram illustrating a first example of a learning method of the machine learning. In the example of FIG. 5C, a plurality of pieces of learning data can be obtained from the polishing result of one substrate. That is, in the example of FIG. 5C, one training data set includes, time-series data of the feature value (for example, a moving average value, a differential value, an integral value, a wear amount of the polishing pad, or a step number of the table torque current) up to a certain time point t, as an input, and the value of output parameters (for example, the residual film amount, the polishing amount, the end point probability, or the predicted value of the remaining polishing time) up to the same time point, as an output.

For example, learning is performed using learning data in which time-series data of the feature value from a start of polishing to a time point t1 is input and a value of the output parameter at the time point t1 is output.

As another learning data, learning is performed using learning data in which time-series data of the feature value from the start of polishing to a time point t2 is input and a value of the output parameter at the time point t2 is output.

As another learning data, learning is performed using learning data in which time-series data of the feature value from the start of polishing to a time point t3 is input and a value of the output parameter at the time point t3 is output.

From the time-series data of the feature values up to the times t1, t2, and t3, learning is performed in which the values of the output parameters at the times t1, t2, and t3 are output.

After the learning is completed, when time-series data of the feature value up to a certain time point is input to the machine learning model in a new polishing, an predicted value (for example, an unknown residual film amount) of the output parameter at the time point is output. For example, RNN or LSTM may be used as the machine learning model. However, a machine learning model (method) other than the RNN or the LSTM may be used.

As illustrated in FIG. 5D, the machine learning model may be trained. FIG. 5D is a schematic diagram illustrating a second example of the learning method of the machine learning. In the example of FIG. 5D, one set of learning data can be obtained from the polishing result of one substrate. That is, in the example of FIG. 5D, the one training data set in which time-series data of the feature value from the start of polishing to the end of polishing is used as an input and time-series data of the output parameter (for example, a residual film amount, a polishing amount, an end point probability, or an predicted value of the remaining polishing time) from the start of polishing to the end of polishing is used as an output. Here, the feature value is a feature value based on data on frictional force between the polishing member and the target substrate at the target time point during polishing. This feature value is, for example, at least one of a moving average value of the table torque current, a differential value of the table torque current, and an integral value of the table torque current. The feature value may additionally or alternatively be a wear amount of the polishing pad or a step number in the polishing recipe. Here, the reason why the step number in the polishing recipe is used as “the feature value based on the data regarding the frictional force between the polishing member and the substrate” is that the polishing condition (airbag pressure, slurry flow rate, and the like) can be changed for each polishing step, and the frictional force between the polishing member and the substrate is changed accordingly. For example, it is possible to set such that the airbag pressure is increased to polish quickly at first, and the airbag pressure is decreased to polish slowly in the second half in order to accurately detect the end point.

That is, learning is performed using the learning data in which the time-series data of the feature value from the start of polishing to the end of polishing is input and the time-series data of the output parameter from the start of polishing to the end of polishing is output.

After the learning is completed, when time-series data of the feature value up to a certain time point is input to the machine learning model in a new polishing, an predicted value (for example, an unknown residual film amount) of the output parameter up to the time point is output. That is, when time-series data of the feature value up to the time point t1 is input to the machine learning model, predicted values (for example, unknown residual film amount) of the output parameter up to the time point t1 are output. In addition, when time-series data of the feature value up to the time point t2 is input to the machine learning model, predicted values (for example, unknown residual film amount) of the output parameter up to the time point t2 are output. Furthermore, when time-series data of the feature value up to the time point t3 is input to the machine learning model, predicted values (for example, unknown residual film amount) of the output parameter up to the time point t3 are output. In this manner, since the plurality of predicted values of the output parameter up to that time point are output, the prediction unit 452 may acquire an predicted value at that time point among the plurality of predicted values. The determination unit 453 may determine whether or not the polishing end point has been reached using the predicted value at that time point.

Subsequently, referring back to FIG. 5A, in the estimation step, in a case where the machine learning model is trained as described with reference to FIG. 5C, when the time-series data of the feature value up to the target time point is input to the trained machine learning model, an predicted value of the polishing amount or the residual film amount at the target time point during polishing of the target substrate is output.

Note that, in a case where the machine learning model is trained as described with reference to FIG. 5D, when the time-series data of the feature value up to the target time point is input to the trained machine learning model, the time-series data of the predicted value of the polishing amount or the residual film amount at the target time point during polishing of the target substrate up to the target time is output.

The input of the machine learning model may further include a polishing recipe, a use time of one consumable member, the number of substrates treated with a same consumable member, and/or an initial film thickness. As a result, it is possible to estimate the polishing amount or the residual film amount according to the polishing conditions and the state of the consumable member, and the estimation accuracy can be improved.

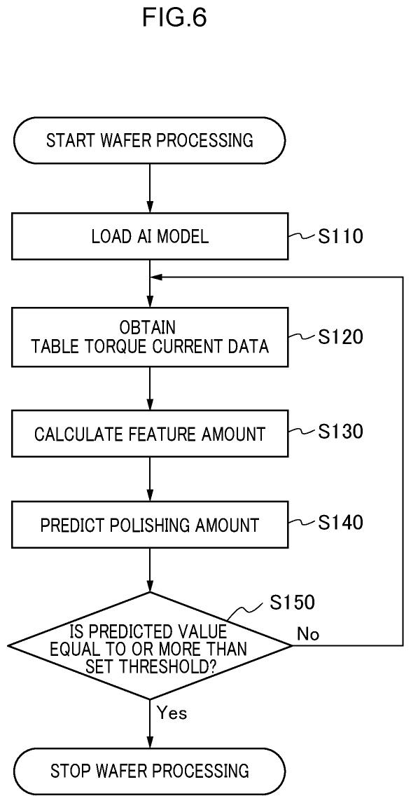

FIG. 6 is a flowchart illustrating a first example of processing the AI unit during polishing of the wafer.

(Step S110) First, the processor 45 loads a trained machine learning model (also referred to as an AI model) from the storage unit 41 into the memory 42.

(Step S120) Next, the processor 45 acquires table torque current data.

(Step S130) Next, the generation unit 451 calculates a feature value from the table torque current data acquired in step S120.

(Step S140) Next, the prediction unit 452 inputs the feature value calculated in step S130 to the trained machine learning model, and outputs an predicted value of the polishing amount at the target time point during polishing of the target substrate.

(Step S150) Next, the determination unit 453 determines whether or not the predicted value of the polishing amount output in step S140 is equal to or more than a set threshold. In a case where the predicted value of the polishing amount is not equal to or more than the set threshold value, the process returns to step 130 and the process is repeated. On the other hand, in a case where the predicted value of the polishing amount is equal to or more than the set threshold value, the determination unit 453 outputs an instruction to stop polishing to the control unit 500, and the control unit 500 that has received the instruction to stop polishing controls the polishing apparatus so as to stop polishing. In this manner, the determination unit 453 controls the polishing apparatus so as to stop polishing by using the predicted value predicted by the prediction unit 452. According to this configuration, since the influence of the consumable members such as a polishing pad and non-uniformity of substrates can be taken into consideration, a deviation range of the polishing amount or the residual film amount at the end of polishing can be reduced.

In practice, as illustrated in the upper diagram of FIG. 4, a detection may be performed at a stage where a predetermined polishing amount or a predetermined polishing time is left before the polishing is stopped and before the predicted value of the polishing amount reaches the target polishing amount, and after that, additional polishing (overpolishing) may be performed before the polishing is stopped. As a result, it is possible to perform control of the polishing apparatus so as to avoid excessive polishing due to a delay in signal processing or to change a condition for additional polishing.

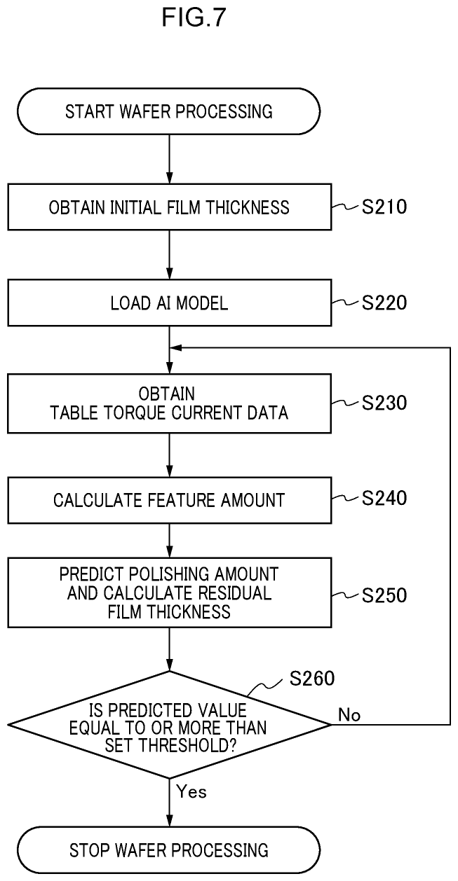

FIG. 7 is a flowchart illustrating a second example of processing the AI unit during polishing of the wafer.

(Step S210) First, the processor 45 acquires an initial film thickness of the substrate.

(Step S220) First, the processor 45 loads a trained machine learning model (also referred to as an AI model) from the storage unit 41 into the memory 42.

(Step S230) Next, the processor 45 acquires table torque current data.

(Step S240) Next, the generation unit 451 calculates a feature value from the table torque current data acquired in step S230.

(Step S250) Next, the prediction unit 452 inputs the feature value calculated in step S230 to the trained machine learning model, outputs an predicted value of the polishing amount at the target time point during polishing of the target substrate, and calculates an predicted value of the residual film thickness by subtracting the predicted value of the polishing amount from the initial film thickness acquired in step S210.

(Step S260) Next, the determination unit 453 determines whether or not the predicted value of the residual film thickness output in step S250 is equal to or less than a set threshold value. In a case where the predicted value of the residual film thickness is not equal to or less than the set threshold value, the process returns to step 230 and repeats the processing. On the other hand, in a case where the predicted value of the residual film thickness is equal to or less than the set threshold value, the determination unit 453 outputs an instruction to stop polishing to the control unit 500, and the control unit 500 that has received the instruction to stop polishing controls the polishing apparatus so as to stop polishing.

Note that, in a case where a machine learning model trained with a training data set including, as an input, a feature value based on data regarding a frictional force at each time point during polishing, and as an output, a residual film amount at each time point during polishing predicted using at least a film thickness measured after polishing, in step S240, an predicted value of the residual film thickness may be directly output from the trained machine learning model, instead of the predicted value of the polishing amount.

As described above, the information processing system S according to the first embodiment includes the generation unit 451 that generates the feature value based on the data regarding the frictional force between the polishing member and the target substrate at the target time point during polishing. Furthermore, the information processing system S includes the prediction unit 452 that inputs at least the feature value generated by the generation unit 451 to the machine learning model trained with the training data set, that includes, as an input, a feature value based on data regarding the frictional force between the polishing member and the substrate at each time point during polishing, and as an output, a polishing amount or a residual film amount at each time point during polishing predicted using at least a film thickness measured after polishing, and outputs an predicted value of the polishing amount or the residual film amount at a target time point during polishing of the target substrate.

With this configuration, a relationship between a feature value related to a change in a frictional force or temperature when polishing is performed and a polishing amount or a residual film amount as a result of polishing is trained, and the polishing amount or the residual film amount during polishing of a new substrate is predicted using the trained machine learning model. By the learning of the machine learning model, the trained machine learning model can estimate a polishing amount or a residual film amount in consideration of the influence of the consumable member such as the polishing pad and the non-uniformity of polishing. Therefore, it is possible to estimate the polishing amount or the residual film amount during polishing of a new substrate in consideration of the influence of the consumable member such as the polishing pad and the non-uniformity of polishing. By using the predicted value for detecting the polishing end point of the target substrate, it is possible to realize end point detection capable of suppressing the difference in residual film thickness between the substrates even if the polishing situation changes.

<First Modification of First Embodiment>

Next, a first modification of the first embodiment will be described. In the first modification, the storage unit 41 stores a machine learning model trained with a training data set in which at least a feature value based on data regarding a frictional force at each time point during polishing or a feature value based on temperature measurement data is used as an input, and a polishing end point probability at each time point during polishing is used as an output. The polishing end point probability is that, for example, the output of the learning data based on the data up to the middle of polishing is set to 0, and the output of the learning data based on the polishing data reaching an ideal polishing end point or an ideal detection point is set to 1.

The generation unit 451 generates a feature value using data related to a frictional force between the polishing member and the target substrate at a target time point during polishing.

The prediction unit 452 inputs at least the feature value generated by the generation unit 451 to the trained machine learning model stored in the storage unit 41, and outputs an predicted value of the polishing end point probability at the target time point.

With this configuration, by using the machine learning model, for example, it is possible to perform inference by storing not only the instantaneous value of the feature value of the data but also the waveform change, so that it is possible to estimate the polishing end point probability in consideration of the influence of non-uniformity of the consumable member such as the polishing pad or the substrate. Then, by using an predicted value of the polishing end point probability for polishing termination control, it is possible to reduce the difference in residual film thickness between the substrates after polishing.

The determination unit 453 controls the polishing apparatus so as to stop polishing by using the predicted value predicted by the prediction unit 452.

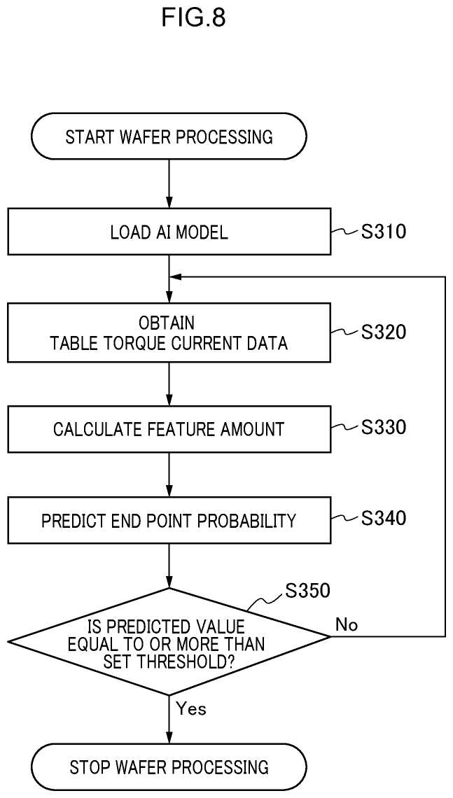

FIG. 8 is a flowchart illustrating an example of processing of the AI unit during polishing of the wafer in the first modification of the first embodiment.

(Step S310) First, the processor 45 loads a trained machine learning model (also referred to as an AI model) from the storage unit 41 into the memory 42.

(Step S320) Next, the processor 45 acquires table torque current data.

(Step S330) Next, the generation unit 451 calculates a feature value from the table torque current data acquired in step S320.

(Step S340) Next, the prediction unit 452 inputs the feature value calculated in step S330 to the trained machine learning model, and outputs an predicted value of the polishing end point probability at the target time point.

(Step S350) Next, the determination unit 453 determines whether or not the predicted value of the polishing end point probability output in step S340 is equal to or larger than a set threshold. In a case where the predicted value of the polishing end point probability is not equal to or more than the set threshold value, the process returns to step 320 and the process is repeated. On the other hand, in a case where the predicted value of the polishing end point probability is equal to or more than the set threshold value, the determination unit 453 outputs an instruction to stop polishing to the control unit 500, and the control unit 500 that has received the instruction to stop polishing controls the polishing apparatus so as to stop polishing. As described above, in a case where the determination unit 453 determines that the polishing end point has been reached, the control unit 500 controls the polishing apparatus to stop polishing. According to this configuration, the relationship between the feature value related to a change in a frictional force or temperature when polishing is performed and the polishing end point probability at each time point during polishing is trained, and a polishing end point probability at each time point during polishing of a new substrate is predicted using the trained machine learning model. By the learning of the machine learning model, the trained machine learning model can estimate a polishing end point probability at each time point during polishing in consideration of the influence of the consumable member such as the polishing pad and the non-uniformity of polishing, and thus, it is possible to estimate the polishing end point probability at each time point during polishing of a new substrate in consideration of the influence of the consumable member such as the polishing pad and the non-uniformity of polishing. By using the predicted value for detecting the polishing end point of the target substrate, it is possible to realize end point detection capable of suppressing the difference in residual film thickness between the substrates even if the polishing situation changes.

<Second Modification of First Embodiment>

Next, a second modification of the first embodiment will be described. In the second modification, the storage unit 41 stores a machine learning model trained with a training data set that includes, as an input, at least a feature value based on data regarding a frictional force at each time point during polishing, and as an output, remaining polishing time or additional polishing time from an end point detection timing determined so that a residual film thickness or a polishing amount becomes a target value. Here, the predicted value of the additional polishing time from the end point detection timing is an predicted value of the time for additional polishing from the end point detection timing until the target residual film thickness illustrated in FIG. 4 is obtained.

The generation unit 451 generates a feature value using data related to a frictional force between the polishing member and the target substrate at the target time point during polishing or temperature measurement data of the polishing member or the substrate.

The prediction unit 452 inputs at least the feature value generated by the generation unit 451 to the trained machine learning model stored in the storage unit 41, and outputs an predicted value of the remaining polishing time or the additional polishing time from the end point detection timing.

With this configuration, by using the machine learning model, for example, it is possible to perform inference by storing not only the instantaneous value of the feature value of data but also the waveform change, so that it is possible to estimate the remaining polishing time or the additional polishing time from the end point detection timing in consideration of the influence of non-uniformity of the consumable member such as the polishing pad or the substrate. Then, by using the predicted value of the remaining polishing time or the additional polishing time from the end point detection timing for polishing termination control, it is possible to reduce the difference in residual film thickness between the substrates after polishing.

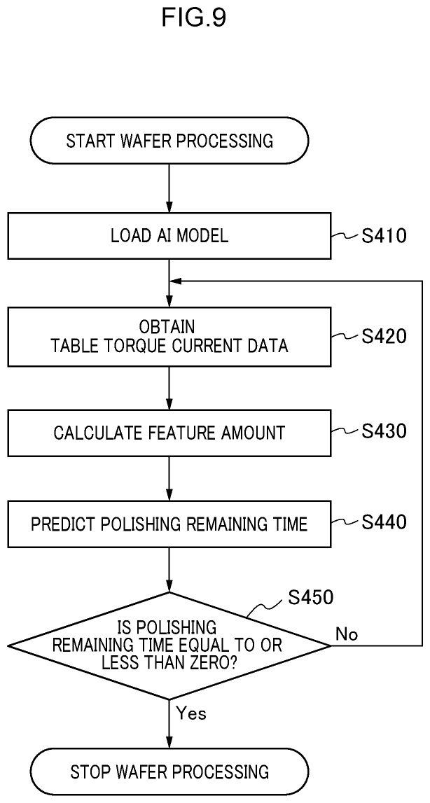

FIG. 9 is a flowchart illustrating an example of processing of the AI unit during polishing of the wafer in the second modification of the first embodiment.

(Step S410) First, the processor 45 loads a trained machine learning model (also referred to as an AI model) from the storage unit 41 into the memory 42.

(Step S420) Next, the processor 45 acquires table torque current data.

(Step S430) Next, the generation unit 451 calculates a feature value from the table torque current data acquired in step S420.

(Step S440) Next, the prediction unit 452 inputs the feature value calculated in step S430 to the trained machine learning model and outputs an predicted value of the remaining polishing time.

(Step S450) Next, the determination unit 453 determines whether or not the predicted value of the remaining polishing time output in step S440 is 0 or less. If the predicted value of the polishing end point probability is not 0 or less, the process returns to step 420 and repeats the process. On the other hand, in a case where the predicted value of the polishing end point probability is 0 or less, the determination unit 453 outputs an instruction to stop polishing to the control unit 500, and the control unit 500 that has received the instruction to stop polishing controls the polishing apparatus so as to stop polishing. As described above, in a case where the determination unit 453 determines that the polishing end point has been reached, the control unit 500 controls the polishing apparatus to stop polishing. According to this configuration, the relationship between the feature value related to a change in the frictional force or temperature at the time of polishing and the remaining polishing time or the additional polishing time from the end point detection timing is trained, and a remaining polishing time or additional polishing time from the end point detection timing during polishing of a new substrate is predicted using the trained machine learning model. By the learning of the machine learning model, the trained machine learning model can estimate the remaining polishing time or the additional polishing time from the end point detection timing in consideration of the influence of the consumable member such as the polishing pad and the non-uniformity of polishing. Therefore, the remaining polishing time or the additional polishing time from the end point detection timing during the polishing of the new substrate can be predicted in consideration of the influence of the consumable member such as the polishing pad and the non-uniformity of polishing. By using the predicted value for detecting the polishing end point of the target substrate, it is possible to realize end point detection capable of suppressing the difference in residual film thickness between the substrates even if the polishing situation changes.

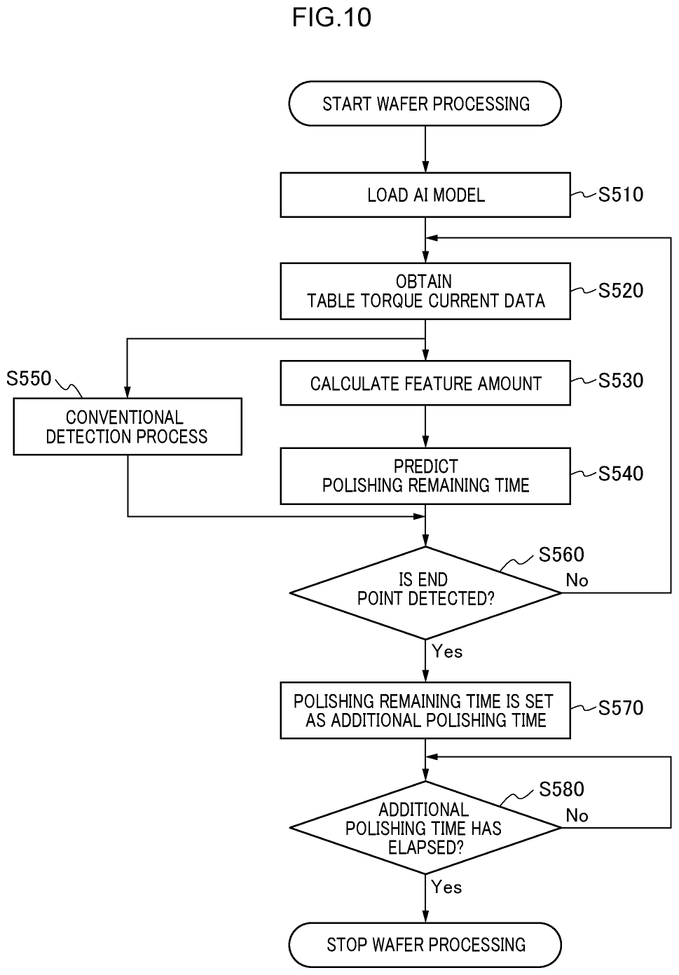

FIG. 10 is a flowchart illustrating another example of processing the AI unit during polishing of the wafer in the second modification of the first embodiment.

(Step S510) First, the processor 45 loads a trained machine learning model (also referred to as an AI model) from the storage unit 41 into the memory 42.

(Step S520) Next, the processor 45 acquires table torque current data.

(Step S530) Next, the generation unit 451 calculates a feature value from the table torque current data acquired in step S520.

(Step S540) Next, the prediction unit 452 inputs the feature value calculated in step S530 to the trained machine learning model and outputs an predicted value of the remaining polishing time.

(Step S550) In parallel to steps 5530 and 5540, the processor 45 executes a conventional end point detection process. For example, the processor 45 detects a polishing end point when a time derivative value of the table torque current falls below a preset threshold.

(Step S560) The processor 45 determines whether or not the polishing end point is detected in step S550, and in a case where the polishing end point is not detected (NO in step S560), the process returns to step S520 and the process is repeated.

(Step S570) On the other hand, when the polishing end point is detected (YES in step S560), the predicted value of the remaining polishing time output by the prediction unit 452 at that timing is set as an additional polishing time (also referred to as overpolishing time).

(Step S580) The determination unit 453 determines whether or not the additional polishing time (overpolishing time) has elapsed after the detection of the polishing end point. In a case where the additional polishing time (overpolishing time) has elapsed after the detection of the polishing end point, the determination unit 453 outputs an instruction to stop polishing to the control unit 500, and the control unit 500 that has received the instruction to stop polishing controls the polishing apparatus so as to stop polishing.

Note that the AI unit 4 may be mounted on a gateway in a factory, which is a gateway to which the polishing apparatus is connected by a network line. This gateway is preferably in a vicinity of the polishing apparatus. In a case where high-speed processing is required (for example, in a case where a sampling rate is 100 ms or less), the AI unit 4 in the polishing apparatus or the AI unit 4 mounted on the gateway may execute the processing as an edge computing. The AI unit 4 in the polishing apparatus may be mounted on a PC as an apparatus or a controller.

### Second Embodiment

Next, a second embodiment will be described. In the first embodiment, the polishing apparatus 10 includes the information processing system having the AI unit 4, but in the second embodiment, there is a difference in that an information processing system S2 having an AI unit 4 is provided not in a polishing apparatus but in a factory management room, a clean room, or the like in a factory.

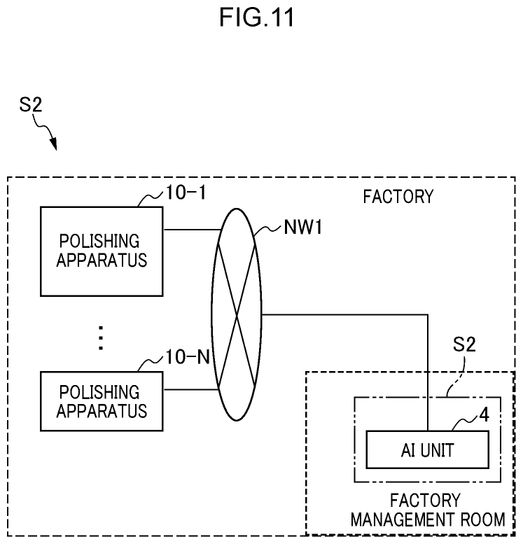

FIG. 11 is a schematic view illustrating an overall configuration of a polishing system according to a second embodiment. As illustrated in FIG. 11, the polishing system according to the second embodiment includes polishing apparatuses 10-1 to 3-N, and an information processing system S2 provided in a same factory as the polishing apparatuses 10-1 to 10-N is provided or in a factory management room. The information processing system S2 includes an AI unit 4, and the AI unit 4 can communicate with the polishing apparatuses 10-1 to 3-N via a local network NW1. The AI unit 4 is mounted on, for example, a computer (for example, a server or fog computer).

In a case where the AI unit 4 is provided in the polishing apparatus or the gateway, it is possible to perform high-speed processing by executing a trained machine learning model by edge computing. For example, it is possible to perform processing at high speed on time (in real time).

In addition, in a case where the AI unit 4 is mounted on a server or a fog computer in a factory, data of a plurality of polishing apparatuses in the factory may be collected to update the machine learning model. In addition, data of a plurality of polishing apparatuses in the factory may be collected and analyzed, and the analysis result may be reflected in setting polishing parameters.

### Third Embodiment

Next, a second embodiment will be described. In the first embodiment, the polishing apparatus 10 includes the AI unit 4, but in the second embodiment, the AI unit 4 is provided not in the polishing apparatus but in the analysis center.

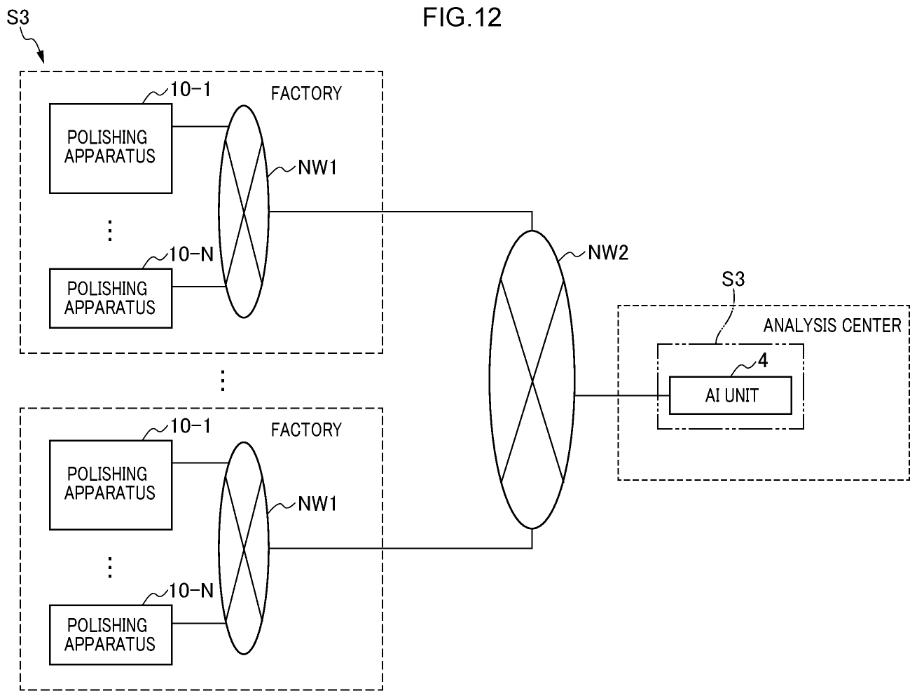

FIG. 12 is a schematic view illustrating an overall configuration of a polishing system according to a third embodiment. As illustrated in FIG. 12, the polishing system according to the third embodiment includes polishing apparatuses 10-1 to 10-N provided in a plurality of factories and an information processing system S3 provided in an analysis center. The information processing system S3 includes an AI unit 4, and the AI unit 4 can communicate with the polishing apparatuses 10 -1 to 10-N via a global network NW2 and a local network NW1. The AI unit 4 is, for example, a computer (for example, a server).

By providing the AI unit 4 in the analysis center physically separated from the polishing apparatus in this manner, the AI unit 4 can be shared among the plurality of factories, and maintainability of the AI unit 4 is improved. Further, by utilizing data during polishing in a plurality of factories to cause the machine learning model to relearn with a large amount of data, estimation accuracy can be improved more quickly.

In addition, the machine learning model may be updated by collecting data (for example, a large amount of data) of a plurality of polishing apparatuses across a plurality of factories. In addition, data (for example, a large amount of data) of a plurality of polishing apparatuses across a plurality of factories may be collected and analyzed, and the analysis result may be reflected in setting polishing parameters.

Note that the AI unit 4 may be provided in a cloud instead of the analysis center that intensively performs analysis.

A mounting place of the AI unit 4 may be (1) in the polishing apparatus, and/or (2) a gateway in the vicinity of the polishing apparatus, and/or (3) a computer (PC, server, fog computer, and the like) in a factory (for example, in a factory management room).

A mounting place of the AI unit 4 may be (1) in the polishing apparatus, and/or (2) a gateway near the polishing apparatus, and/or (4) a computer in an analysis center (or cloud).

A mounting place of the AI unit 4 may be (1) in the polishing apparatus and/or (2) a gateway in the vicinity of the polishing apparatus, and/or (3) a computer in a factory (for example, in a factory management room), and/or (4) a computer in an analysis center (or cloud).

In addition, each configuration of the AI unit 4 may be dispersedly arranged in (1) the inside of the polishing apparatus and/or (2) the gateway in the vicinity of the polishing apparatus, and/or (3) the computer (PC, server, fog computer, and the like) in the factory (for example, in a factory management room), and/or (4) the computer of the analysis center (or cloud).

Note that, in each embodiment, the input of the machine learning model is a feature value based on data regarding the frictional force between the polishing member and the substrate at each time point during polishing, but is not limited thereto. The input of the machine learning model may be a feature value based on temperature measurement data of the polishing member (here, the polishing pad 101) or the substrate at each time point during polishing. This is because when the frictional force between the polishing member and the substrate during polishing increases, a calorific value of the polishing member or the substrate increases accordingly, and a temperature of the polishing member or the substrate increases, so that the temperature of the polishing member or the substrate has a positive correlation with the frictional force between the polishing member and the substrate during polishing.

For example, in the case of the first embodiment, the storage unit 41 may store a machine learning model trained with a training data set in which at least a feature value based on temperature measurement data of a polishing member or a substrate at each time point during polishing is input, and a polishing amount or a residual film amount at each time point during polishing predicted using at least a film thickness measured after polishing is output.

In this case, the generation unit 451 may generate a feature value using temperature measurement data of the polishing member or a target substrate at a target time point during polishing. Then, the prediction unit 452 may input at least the feature value generated by the generation unit 451 to the trained machine learning model and output an predicted value of the polishing amount or the residual film amount at the target time point during polishing of the target substrate.

In addition, for example, in the case of the first modification of the first embodiment, the storage unit 41 may store a machine learning model trained with a training data set in which at least a feature value based on temperature measurement data of a polishing member or a substrate at each time point during polishing is an input and a polishing end point probability at each time point during polishing is an output.

In this case, the generation unit 451 may generate a feature value using temperature measurement data of the polishing member or a target substrate at a target time point during polishing. Then, the prediction unit 452 may input at least the feature value generated by the generation unit 451 to the trained machine learning model and output the predicted value of the polishing end point probability at the target time.

In addition, for example, in the case of the second modification of the first embodiment, the storage unit 41 may store a machine learning model trained with a training data set in which at least a feature value based on the temperature measurement data of the polishing member or the substrate at each time point during polishing is input, and a remaining polishing time or an additional polishing time from end point detection timing determined so that the remaining film thickness or the polishing amount becomes a target value is output.

In this case, the generation unit 451 may generate a feature value using temperature measurement data of the polishing member or a target substrate at a target time point during polishing. Then, the prediction unit 452 may input at least the feature value generated by the generation unit 451 to the trained machine learning model and output an predicted value of the remaining polishing time or the additional polishing time from the end point detection timing.

Note that at least a part of the AI unit 4 described in the above-described embodiment may be configured by hardware or software. In a case where the AI unit 4 is configured by software, a program for realizing at least some functions of the AI unit may be stored in a recording medium such as a flexible disk or a CD-ROM, and may be read and executed by a computer. The recording medium is not limited to a removable recording medium such as a magnetic disk or an optical disk, and may be a fixed recording medium such as a hard disk device or a memory.

Furthermore, the program for realizing at least some functions of the AI unit 4 may be distributed via a communication line (including wireless communication) such as the Internet. Further, the program may be distributed via a wired line or a wireless line such as the Internet or stored in a recording medium in an encrypted, modulated, or compressed state.

Furthermore, the AI unit 4 may be caused to function by one or a plurality of information processing apparatuses. In a case where a plurality of information processing apparatuses is used, at least one of the information processing apparatuses may be a computer, and the computer may execute a predetermined program to implement a function as at least one means of the AI unit 4.

In an invention of a method, all the processes (steps) may be realized by automatic control by a computer. In addition, progress control between the processes may be performed by a human hand while causing the computer to perform each process. Furthermore, at least a part of all steps may be performed by a human hand.

Note that, in the above embodiment, as illustrated in FIG. 3, the process of polishing the polishing target layer 51 until the lower layer 52 is exposed has been described as an example, but the present technology can also be applied to a process of leaving the polishing target layer to a predetermined thickness without exposing the lower layer and terminating polishing. As compared with the process of exposing the lower layer, a signal related to the frictional force or the temperature hardly changes, but it is possible to stop polishing so as to obtain a residual film amount closer to the target value by learning how long and what numerical value the unchanged state continues.

In addition, the present technology may be used not only for determining the end of polishing, but also for changing a polishing condition (for example, a polishing pressure or the like) in a case where the polishing amount or the residual film amount predicted during polishing deviates from a predetermined condition, and for example, polishing may be performed so that a target polishing amount is obtained without increasing a polishing time.

As described above, the present technology is not limited to the above-described embodiment as it is, and can be embodied by modifying the components without departing from the gist of the present technology at an implementation stage. In addition, various inventions can be formed by appropriately combining a plurality of constituent elements disclosed in the above embodiment. For example, some components may be deleted from all the components illustrated in the embodiments. Furthermore, constituent elements in different embodiments may be appropriately combined.

### REFERENCE SIGNS LIST

1 Polishing head
100 Polishing table
100a Table shaft
101 Polishing pad
101a Polishing surface
102 Table rotating motor
110 Top ring head
111 Top ring shaft
112 Rotary cylinder
113 Timing pulley
114 Top ring rotating motor
115 Timing belt
116 Timing pulley
117 Top ring head shaft
124 Vertical movement mechanism
126 Bearing
128 Bridge
129 Support base
130 Strut
132 Ball screw
132a Screw shaft
132b Nut
138 Servomotor
20 Front load unit
21 FOUP
22 Transport robot
26 Rotary joint
3 Retainer ring
4 AI unit
41 Storage unit
42 Memory
43 Input unit
44 Output unit
45 Processor
451 Generation unit
452 Estimation unit
453 Determination unit
500 Control unit
S1 to S3 Information processing system

What is claimed is:

1. A polishing apparatus comprising:
a generation unit configured to generate time-series data of a feature value up to a target time point by using data regarding a frictional force between a polishing member and a target substrate up to the target time point during polishing or a temperature measurement data of the polishing member or the target substrate; and
an prediction unit configured to input at least the time-series data of the feature value generated by the generation unit to a machine learning model trained with a training data set including, as an input, time-series data of the feature value up to a specific time point during polishing of another substrate, and as an output, a polishing amount or a residual film amount at the specific time point, or time-series data of the polishing amount or the residual film amount up to the specific time point during polishing, the polishing amount or the residual film amount being predicted using at least a film thickness measured after polishing of the another substrate, and output an predicted value of a polishing amount or a residual film amount at the target time point during polishing of the target substrate.

2. The polishing apparatus according to claim 1, further comprising:
a determination unit configured to determine whether or not an polishing end point has been reached by using the predicted value; and
a control unit configured to control the polishing apparatus so as to stop polishing in a case where the determination unit determines that the polishing end point has been reached.

3. The polishing apparatus according to claim 1, wherein
the input of the machine learning model further includes a polishing recipe, a use time of one consumable member, the number of substrates treated with the consumable member, and/or an initial film thickness.

4. The polishing apparatus according to claim 1, wherein
the polishing amount or the residual film amount at each time point in the training data set is calculated using a first polishing rate until an interface between a polishing target layer and a lower layer is exposed and a second polishing rate after the interface is exposed.

5. A polishing apparatus, comprising:
a generation unit configured to generate time-series data of a feature value up to a target time point by using data regarding a frictional force between a polishing member and a target substrate up to a target time point during polishing or a temperature measurement data of the polishing member or the target substrate;
an prediction unit configured to input at least the time-series data of the feature value generated by the generation unit to a machine learning model trained with a training data set that includes, as an input, time-series data of the feature value up to a specific time point during polishing of another substrate and as an output, a polishing end point probability at the specific time point during polishing of the another substrate or time-series data of the polishing end point probability up to the specific time point, and output an predicted value of the polishing end point probability at the target time point of the target substrate; and
a determination unit configured to determine whether or not a polishing end point has been reached by using the predicted value.

6. The polishing apparatus according to claim 5, further comprising:
a control unit configured to control the polishing apparatus so as to stop polishing in a case where the determination unit determines that the polishing end point has been reached.

7. A polishing apparatus, comprising:
a generation unit configured to generate time-series data of a feature value up to a target time point by using data regarding a frictional force between a polishing member and a target substrate up to the target time point during polishing or a temperature measurement data of the polishing member or the target substrate; and
an prediction unit configured to input at least the time-series data of the feature value generated by the generation unit to a machine learning model trained with a training data set including, as an input, time-series data of the feature value up to a specific time point during polishing of another substrate, and as an output, a remaining polishing time at the specific time point or an additional polishing time from an end point detection timing, or time-series data of the a remaining polishing time up to the specific time point or the additional polishing time from the end point detection timing, the remaining polishing time or the additional polishing time being determined such that a remaining film thickness or a polishing amount of the another substrate becomes a target value, and output an predicted value of the remaining polishing time or the additional polishing time from an end point detection timing of the target substrate; and
a determination unit that determines whether or not a polishing end point has been reached by using the predicted value.

8. The polishing apparatus according to claim 7, further comprising:
a control unit configured to control the polishing apparatus so as to stop polishing by using the predicted value of the remaining polishing time or the additional polishing time from the end point detection timing.

9. A program for causing a computer to function as:
a generation unit configured to generate time-series data of a feature value up to a target time point by using data regarding a frictional force between a polishing member and a target substrate up to the target time point during polishing or a temperature measurement data of the polishing member or the target substrate; and
an prediction unit configured to input at least the time-series data of the feature value generated by the generation unit to a machine learning model trained with a training data set including, as an input, time-series data of the feature value up to a specific time point during polishing of another substrate, and as an output, a polishing amount or a residual film amount at the specific time point during polishing, or time-series data of the polishing amount or the residual film amount up to the specific time point, the polishing amount or the residual film amount being predicted by using at least a film thickness measured after polishing of the another substrate, and output an predicted value of the polishing amount or the residual film amount at the target time point during polishing of the target substrate.

10. A program for causing a computer to function as:
a generation unit configured to generate time-series data of a feature value up to a target time point by using data regarding a frictional force between a polishing member and a target substrate up to the target time point during polishing or a temperature measurement data of the polishing member or the target substrate; and
an prediction unit that inputs at least the time-series data of the feature value generated by the generation unit to a machine learning model trained with a training data set that includes, as an input, time-series data of the feature value up to a specific time point during polishing of another substrate, and as an output, a polishing end point probability at the specific time point or time-series data of the polishing end point probability up to the specific time point during polishing of the another substrate, and outputs an predicted value of the polishing end point probability at the target time point.

11. A program for causing a computer to function as:
a generation unit configured to generate time-series data of a feature value up to a target time point by using data regarding a frictional force between a polishing member and a target substrate up to the target time point during polishing or a temperature measurement data of the polishing member or the target substrate; and
an prediction unit configured to input at least time-series data of the feature value generated by the generation unit to a machine learning model trained with a training data set including, as an input, time-series data of the feature value up to a specific time point during polishing of another substrate, and as an output, a remaining polishing time at the specific time point or an additional polishing time from an end point detection timing or time-series data of the remaining polishing time up to the specific time point or the additional polishing time from the end point detection timing, the remaining polishing time or the additional polishing time being determined such that a remaining film thickness or a polishing amount of the another substrate becomes a target value, and output an estimation value of the additional polishing time from the remaining polishing time or the end point detection timing of the target substrate.
